(19) United States
(12) Patent Application Publication
(10) Pub. No.: US 2009/0106847 A1
(43) Pub. Date: Apr. 23, 2009

(54) System and Method for Media Rights Transfer

(76) Inventors: Jeff Krupman, Berkeley, CA (US); Ted Sichelman, Berkeley, CA (US)

Correspondence Address: PATENTBEST, 4600 ADELINE ST., #101, EMERYVILLE, CA, 94608, US

(21) Appl. No.: 12/256,298

(22) Filed: Oct. 22, 2008

Related U.S. Application Data
(60) Provisional application No. 60/982,072, filed on Oct. 23, 2007.

(51) Int. Cl. G06F 21/00

(52) U.S. Cl. 726/26

(57) ABSTRACT

Systems and methods for facilitating the playback, viewing, exchange and transfer of media are disclosed. Media, either hard physical media or soft media, are provided to a depository/rights manager that associates the rights to the content of the media with the entity that provided it. Media provided to the depository/rights manager may be digitized, and the rights of the entity to that content may be verified. Once the media is stored by the depository/rights manager, entities, such as individual users, may use it, exchange it, or transfer it using, for example, computers connected to a communication network. In some embodiments, the depository/rights manager may provide an interface, such as an application programming interface (API) that allows the depository/rights manager to handle back-end legal compliance and rights tracking for third-party services and systems.

### CROSS-REFERENCE TO RELATED APPLICATIONS

This application claims priority to, and the benefit of, U.S. Provisional Patent Application No. 60/982,072, filed Oct. 23, 2007, which is incorporated by reference herein in its entirety.

### BACKGROUND OF THE INVENTION

1. Field of the Invention

In general, the invention relates to systems and methods for the transfer of media rights.

2. Description of Related Art

Recently, the storage and exchange of audio, video, text, other data, and related metadata have migrated from “hard,” physical media (e.g., records, film reels, CDs, DVDs, books) requiring “physical” players to “soft” physical media, e.g., data stored in devices and components such as hard drives, MP3 players, SD cards, and requiring software-based players. Originally, audio, video, text, and other data, were presented to users such that the data was encoded in non-electronic means, including vinyl phono-records, printed books, and celluloid films. Eventually, data was encoded in certain electronic media, such as analog audio and videotape, then eventually “hard” digital media, such as digital audiotape, audio CDs, and DVDs, wherein the media would typically be read by a physical “player” connected to some output device (such as a stereo or television). Finally, in recent years, data has been encoded in “soft” digital media, and stored in devices such as hard drives, MP3 players, CF and SD cards, USB memory sticks, and the like, to be played by a software-based “player,” such as Windows Media Player (Microsoft, Inc., Redmond, Wash.).

The proliferation of multiple media formats has made it difficult for end-user consumers to easily store, exchange, transmit, and play and display the multiple forms of audio, video, text, and other data to which an end-user has access. For instance, a given end-user may own, possess, or license printed books, phono-records, audiotapes, videotapes, laserdiscs, audio CDs, video DVDs, MP3 files, MPEG files, eBooks, cartridges, and other data stored on a variety of media. Readers and players for some of these formats are now obsolete. Present services and related technology allow for “digitizing” (i.e., the conversion into digital format) of analog media as well as the transfer of existing digital data, such that an end-user may have all of his or her data stored in one location and medium, for instance, the user's computer hard drive. Universal players, such as the Windows Media Player, may allow for the playback of these multiple data types. If an end-user wishes to exchange data with other users, however, copyright restrictions generally place limitations on this activity that current digitization technologies do not appropriately take account of. For instance, if a user converts an audio CD to digital format, places the digital files on his or her computer hard drive, then subsequently sells the audio CD to another user without removing the files from his or her hard drive, continuing to play such files, then the user has very likely committed a violation of relevant, current copyright laws. To the extent digitization services are aware of such violations and/or assist in the end-user's violation of copyright restrictions, these services may also be in violation of copyright laws. Moreover, there are often contractual restrictions that further limit an enduser's and digitization services' ability to engage in efficient storage, exchange, transmission, playback, and display of audio, video, text, and other data.

Solutions to these types of restrictions have not been robust. A common method of exchanging an audio CD or DVD, for instance, is to sell the CD or DVD to a physical store that re-sells the CD or DVD to a third party. The same is often done with books and other data in “hard” physical format. Other services allow users to list online items for sale and items wanted, and provide basic matching technology to allow users to trade hard physical media via physical mail services. However, even with online matching services, the user is still left with the chore of physically sending the media to the buyer. Additionally, finding a buyer may be particularly difficult if a user is attempting to sell outdated or obsolete media formats.

### SUMMARY OF THE INVENTION

One aspect of the invention relates to a method. In the method, a depository/rights manager accepts media from a plurality of entities, and associates rights to the accepted media with the entities who submitted the media using a media management database. Once associated, the method involves selectively allowing entities to transfer rights to the content of the media amongst the plurality of entities. In some embodiments and some circumstances, the content of the media may be digitized and the rights of the entities to the content verified.

Another aspect of the invention relates to a system. The system comprises a depository adapted to (1) accept media from a plurality of entities, thereby accepting rights to that media, (2) associate the rights to the content of the media with the respective entity of the plurality of entities that provided the media, (3) store the associations in a media management database, and (4) record transfers of the rights to the media among the plurality of entities in the media management database, the depository being connected to a communications network so as to provide selective access to the media management database.

Other aspects, features, and advantages of the invention will be set forth in the description that follows.

### BRIEF DESCRIPTION OF THE DRAWINGS

The invention will be described with respect to the following drawing figures, in which like numerals represent like elements throughout the figures, and in which:

FIG. 1 is a schematic diagram of a system according to one embodiment of the invention; and

FIG. 2 is a flow diagram of a method used in the operation of the system of FIG. 1.

### DETAILED DESCRIPTION

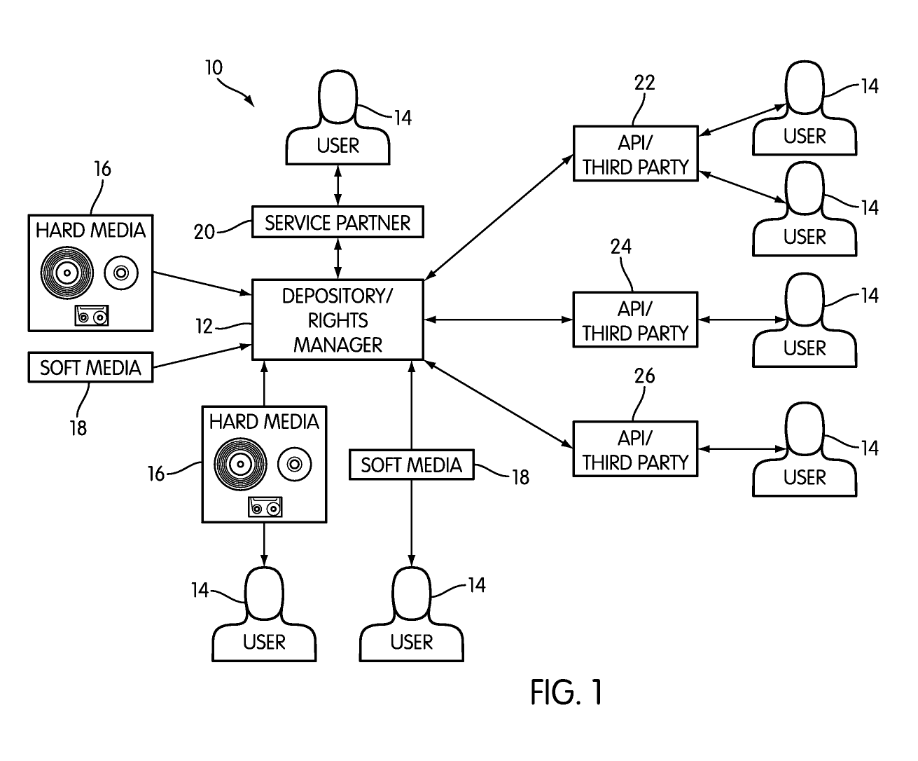

FIG. 1 is a schematic diagram of a system, generally indicated at 10, according to one embodiment of the invention. In general, system 10 is a system for managing the rights to media content. More specifically, system 10 provides a plurality of users 14 with methods for playing, sharing, and exchanging media.

System 10 includes a depository/rights manager 12. In the illustration of FIG. 1, the depository/rights manager 12 is illustrated as being a single, unitary entity, although the depository/rights manager 12 may comprise a plurality of cooperating entities. The depository/rights manager 12 accepts media from a plurality of users 14, associates the rights to the content of the media with the users 14 who provided that media, and maintains a media management database. (It should be understood that the users 14 may be individual users, corporations, or other forms of legal entities, and the term “entities” may be used to describe all types of users.) The content of the media that is provided to the depository/rights manager 12 may be digitized or otherwise converted into an alternate medium or format. Therefore, in general, the depository/rights manager 12 decouples or disassociates a medium from the content of that medium while creating a means for tracking the rights to the content of the medium that relates the content back to physical the physical. This allows the users 14 to play, exchange, and transfer the rights to the media with relative ease, and may facilitate compliance with applicable copyright laws.

“Media” in this context may be either “hard” physical media 16 or soft media 18. Typically, users 14 will have stored in hard physical format many varieties of audio, video, text, and other content, including phono-records, audiotapes and cassettes, videotapes, audio CDs, video laserdiscs, digital audiotape, video DVDs, books, newspapers, magazines, books-on-tape, books-on-CD, and other hard format copies. All of these may be considered forms of hard physical media for purposes of the present description. Users 14 may also have soft media 18, a category that includes content in any digital form (e.g., MP3, AAC, WAV, MP4, etc.).

In one embodiment, users 14 select any of this media 16, 18 and provide it to the depository/rights manager 12, either directly or through a service partner 20, an entity that acts as a middleman and forwards media to the depository/rights manager 12. (In the illustration of FIG. 1, one user 14 is providing hard media 16 to the depository/rights manager 12 and another user 14 is providing soft media 18, although a single user may provide any combination of media 16, 18.) A service partner 20 may scan and convert the media 16, 18 on-site, transmitting it to the depository/rights manager 12. In the event the depository/rights manager 12 only needs verification that a user 14 owns the rights to underlying data or content, the service partner 20 may transmit authorization data, but not any underlying data or content. The service partner 20 may also store the media 16, 18, either on behalf of itself, the user 14, or the depository/rights manager 12.

Soft media 18 may be provided to the depository/rights manager 12 by electronic upload over a communications network, or it may be copied to hard media (CD-ROM, floppy disk, USB drive) and provided to the depository/rights manager 12 in the same way as hard media 16. If soft media 18 is provided over a communications network, then an application on the user's computing device, music player, or other device where the soft media 18 resides could be used to designate files for upload to the depository/rights manager 12.

Of course, users 14 need not provide media to the depository/rights manager 12 themselves. If a user 14 purchases hard physical media 18 from a third-party, which may or may not be a service partner 20, the user 14 may instruct the third-party to ship the hard media 16 directly to the depository/rights manager 12 for conversion and cataloguing. In some instances, the third-party may be the depository/rights manager 12, i.e., the user purchases hard media data from the depository/rights manager 12, which converts that hard media data to soft media data for the user. Additionally, the depository/rights manager 12 may purchase hard media, which it then re-sells or licenses, as applicable, to end-users for subsequent storage, playback, exchange, and so forth.

In some embodiments, the user 14 may direct a third-party seller to directly download an electronic file to the storage devices of the depository/rights manager 12 on behalf of the user 14. This third-party may be the depository/rights manager 12; more particularly, the depository/rights manager 12 may sell or license a digital copy to an end-user directly. Alternatively, a user may assign “ownership” of purchases made from a third party to a computer hosted by the depository/rights manager 12 and assign his (the user's) local computers/devices among the authorized devices for playing the media that is licensed. As part of this process, the depository/rights manager 12 may simply appear as another “device” in a user's profile. Alternatively, the depository/rights manager 12 may purchase soft media directly, which, if feasible, it then sells or licenses to end-users. In general, the ownership and license rights may be coupled or de-coupled from the possession of the underlying media as necessary or desired, and via multiple parties, as necessary or desired.

In general, the depository/rights manager 12 and user 14 may engage in any number of contractually based ownership relations regarding the media 16, 18, either directly, or through any number of intermediaries, either agents of the depository/rights manager 12 or the user 14. Either the user 14 may retain full ownership of the hard media, including any licenses to the underlying data (if any), or the user 14 may transfer all or some of these rights and licenses to the depository/rights manager 12. For example, the user 14 may transfer ownership of the physical media data to the depository/rights manager 12, taking a license back to play such media. Alternatively, the depository/rights manager 12 may purchase hard media, then sell or license any rights to the media to an end-user. Generally speaking, the ownership and license rights may be coupled or de-coupled from the possession of the underlying media as necessary or desired, and via multiple parties, as necessary or desired.

It should be understood that although media 16, 18 may be provided by individual users 14, as described above and shown in FIG. 1, other types of entities may also contribute media. For example, music publishers and distributors may directly contribute rights to works in their respective catalogs, and some entities may provide media without seeking to retain the rights to the content of that media. For those reasons, some of the media 16, 18 shown in FIG. 1 is not shown as being associated with any particular user 14.

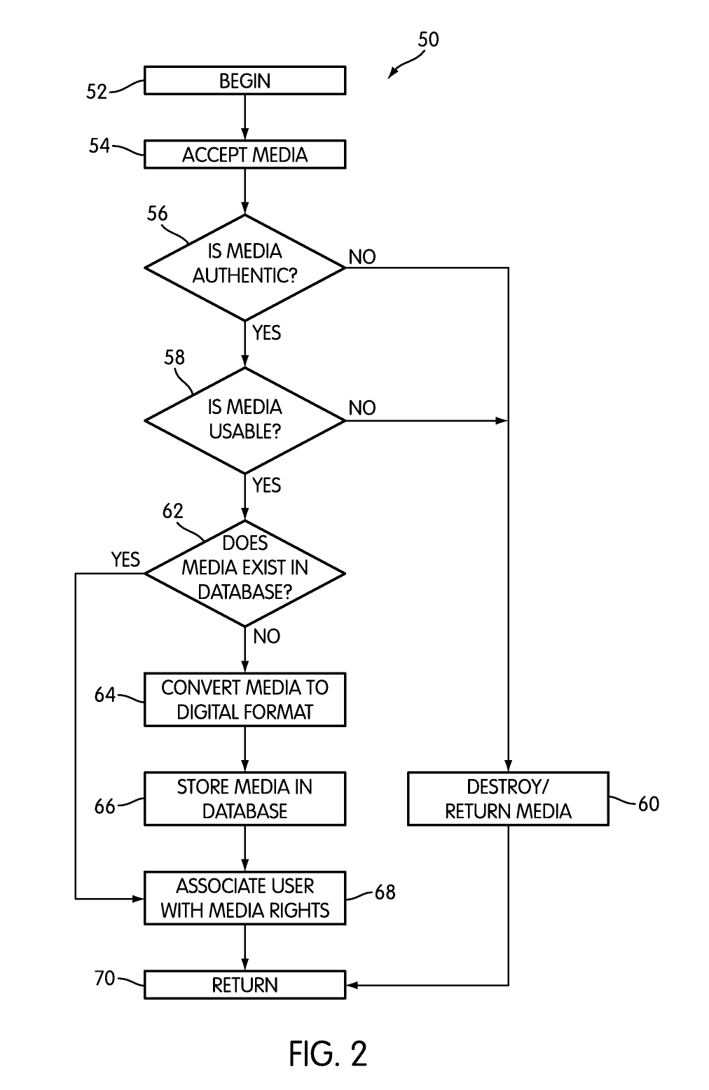

Once the media is accepted by the depository/rights manager 12, the depository/rights manager 12 may process the media in a variety of ways. FIG. 2 illustrates a method, generally indicated at 50, for processing accepted media. Most of the tasks of method 50 are similar for both hard and soft media 16, 18; therefore, a description of the tasks involved for one type of media 16, 18 may be assumed to apply to the other type of media 16, 18 unless indicated otherwise.

Method 50 begins at task 52 and continues with task 54 when media is submitted and/or received. In most embodiments, once media has been received in task 52, it is helpful if the depository/rights manager 12 undertakes at least some tasks to determine whether the media is valid and whether the submitting entity's rights to the content of the media are valid. In method 50, those tasks begin with task 56, in which the depository/rights manager 12 determines whether the media is authentic.

In task 56, for example, the depository/rights manager 12 may visually inspect the media to determine whether the packaging is original or reproduced. Alternatively, the depository/rights manager 12 may digitally scan the data residing on the hard media to determine if that data was copied or is original, or if the data contains other indications that it may not have been legitimately purchased. Similarly, the depository/rights manager 12 may wish to determine if the media is an unauthorized “bootleg” copy that violates applicable copyright protection. If the media is authentic (task 56:YES), method 50 continues with task 58; if the media is not authentic (task 56:NO), method 50 continues with task 60, in which the media may be destroyed or returned to the entity that provided it, and may also be reported to the authorities, depending on the embodiment and the particular circumstances.

Additionally, the depository/rights manager 12 may provide for an application programming interface (API) or other similar system and/or method to allow for third parties (e.g., copyright holders or their agents) to monitor and audit the depository/rights manager 12's actions in terms of ensuring copyright and other restrictions are appropriately enforced. For example, a third party may through this system be able to confirm that a particular audio CD has not been exchanged multiple times by a single user.

The depository/rights manager 12 may also wish to determine whether the media is useable, and that is done in task 58 of method 50. For instance, for an audio CD, the depository/rights manager 12 may wish to determine the number of intact and readable bits of data. For a phonograph, the depository/rights manager 12 may simply visually inspect the record for scratches and other signs of wear. The depository/rights manager 12 may wish to return or discard media that does not meet certain minimum quality criteria. The criteria may take the form of a score, e.g., on a scale of 1100. For digital media, this score might represent the % of total bits on a song-by-song basis that are readable. More specifically, for digital media, a comparison between a given copy submitted by a user and a “pristine” or “master” copy will result in a differential that may be used to grade media and identify errors and/or unreadable data. In the event that a user has sufficient rights to view and/or exchange portions of an audio CD or video DVD (or other type of data), ratings may be applied on a “track-by-track,” “chapter-by-chapter,” or other similar temporal basis.

If the media 16, 18 meets whatever criteria the depository/rights manager 12 may impose (task 58:YES), method 50 continues with task 62. If the media 16, 18 does not meet that criteria, then method 50 continues with task 60, and the media is returned, destroyed, or dealt with in some other way appropriate to the circumstances.

In task 62, the depository/rights manager 12 determines whether a copy of the media is already being stored. In some instances, if the depository/rights manager 12 is already storing the same or substantially similar underlying data submitted by a user 14, the depository/rights manager 12 may wish to simply verify that underlying data is intact and of suitable quality, but not actually convert that data to soft media 18. Rather, an electronic shortcut, link, pointer, or placeholder may be utilized to associate the rights or licenses of the user 14 with the underlying data to the “reference” data stored by the depository/rights manager 12, as will be described below in more detail. In other instances, the depository/rights manager 12 may keep each user's contributed copy of media data in a separate converted form for delivery to that user.

For example, many users may own “Abbey Road” by The Beatles. If a user 14 provides that album to the depository/rights manager 12, the depository/rights manager 12 may decide not to store the original data of the user 14 in digital format if such data is the same or substantially similar to that provided by another user 14 and stored by the depository/rights manager 12. Instead, an electronic shortcut, link, pointer, or placeholder may be utilized to associate the user 14's rights or licenses to the underlying data to the data stored by the depository/rights manager 12.

Alternatively, the user 14 may in some circumstances transfer metadata related to the underlying media data stored in hard or soft format to the depository/rights manager 12. The depository/rights manager 12 may then verify the validity of such metadata to determine whether the user 14 owns legitimate rights or is suitably licensed to play or view the underlying media data. If so, the depository/rights manager 12 may then use an electronic shortcut, link, pointer, or placeholder may to associate the user 14's rights or licenses to the underlying data stored by the depository/rights manager 12, as will be described in greater detail below.

In the event that the media provided by a user 14 is being stored already (task 62:YES) but is of different quality that that provided by the user 14, e.g., record, audiotape, CD, standard DVD, Blu-ray DVD, etc., the depository/rights manager 12 may employ multiple reference copies of different quality for varying qualities of media data. In some instances, the depository/rights manager 12 may employ one “reference” copy, using appropriate algorithms to adjust the quality of the reference copy as needed, for example, in order to match the quality of various underlying media data contributed by users. In other instances, the quality of media may be adjusted depending on the bandwidth available to the user and/or depository/rights manager 12.

If a copy of the media 16, 18 is not already being stored (task 62:NO), method 50 continues with task 64, and the media is converted to a digital format for storage. If a copy of the media 16, 18 is already being stored, method 50 continues with task 68.

In task 64, the depository/rights manager 12 converts the hard media data into soft media format. For instance, an audio CD would be scanned and converted into pure soft audio format files, such as the MPEG format. A phonograph record would be digitized into a suitable pure soft audio format. A book might be scanned and converted to soft image files, such as the PDF format. If the hard media data is in a digital format to begin with, e.g., an audio CD, the conversion process may simply involve copying the digital data from the medium and storing it. Analog data, on the other hand, could be converted into digital format before any subsequent storage.

In addition to the raw media data comprising a book, audio CD, video DVD, etc., there is often additional material, such as cover art, book jackets, liner notes, lyrics, and so forth, that accompanies the hard media data. The depository/rights manager 12 may wish to scan and convert this accompanying data info soft format as well for presentation to users 14. Optical character recognition (OCR) may be used to convert the data into searchable and other usable formats, e.g., to allow users to search for songs containing particular words, to read reviews printed on a book jacket, or to display text lyrics at the bottom of a user's computer screen as a song plays on speakers.

After the depository/rights manager 12 receives, converts, stores, and catalogues (as needed) the data, the depository/rights manager 12 may then store the hard physical media in a warehouse, catalogued by the end user's name and/or other characteristics. Alternatively, the depository/rights manager 12 may wish to send the hard physical data back to the user 14. In some embodiments, a service partner 20 may store the hard physical media on-site or in its storage facilities.

Method 50 continues with task 68, in which the depository/rights manager associates the media 16, 18 with the user 14 who provided it. In the simplest embodiments with hard media, this may involve nothing more than labeling the physical media 16 with the name of the user 14. However, in most embodiments, the association may be done by way of a media management database that records identifying information for the user 14, the nature of the media or content to which the user 14 has rights, and any other information that may be desirable for allowing the user to view, play, or otherwise derive benefit from the content, such as the capabilities of the media player or computer used by the user 14 and/or the range of media formats that the user 14 can accept. In some embodiments, the media management database may also contain a history of transactions that represents the chain of title for each medium or piece of content; however, this information may also be stored separately.

After task 68, method 50 returns at task 70. Method 50 may be executed many times in series or parallel for different users, each time a content-containing medium is provided to the depository/rights manager 12.

As a result of method 50, with the media management database that contains the associations between the users, the media, and the rights to the content of the media, the depository/rights manager 12 essentially has a library or directory for each user 14 of that user's media and content. In some embodiments, the depository/rights manager 12, or a service provider associated with it, may allow users 14 to access that library via a communications network, such as the Internet, to perform a variety of functions.

The directory provided by the depository/rights manager 12 may indicate whether a particular set of data, e.g., an album, is available for download, streaming, and exchange or transfer, and under what conditions. For instance, a user may specify that he or she wishes to sell “Abbey Road” by The Beatles for no less than US$8 or 10 user “credits,” and to be able to stream or download the album until such time the album is exchanged (i.e., bought, sold, traded, etc.) for at least the minimum specified amount.

As described above, “hard” format data converted into “soft” format and “soft” format data transmitted to the depository/rights manager 12 is stored on the user's behalf to be made available to the user for playback or viewing (either via live streaming or via download), or other use via any sensory modality. However, as was noted above, in some cases, the depository/rights manager 12 may store only a single reference copy of a particular piece of content, or a set of reference copies of different quality. Generally speaking, once media has been provided to the depository/rights manager 12, the user 14 has access to that which he or she has provided, and unless a particular embodiment or circumstance requires that restrictions be placed on the content, the user 14 may do with the content of the media held by the depository/rights manager 12 many of the things that the user 14 could do with the original media and its content, albeit with the added flexibility that digital formats and communications networks can provide.

In some circumstances, the depository/rights manager 12 may encode all such data with appropriate “digital rights management” (DRM) if needed to comply with copyright and other restrictions. The addition of DRM may be performed during the scanning and conversion process described above. Alternatively, the depository/rights manager 12 may store the data without DRM and provide the user 14 with data that contains DRM restrictions.

The DRM restrictions may limit the user's ability to copy, transfer, play, or view the data in a variety of manners. For instance, the DRM restrictions may require that the user synchronize a compatible mobile device, such as an MP3 player, with the depository/rights manager 12 every month in order to keep active the DRM license so as to play or view media “active.” Additionally, the DRM may restrict the user from copying the data to more than one mobile device. The DRM may also prevent unauthorized transfer of the media data to other individuals.

The DRM used by the depository/rights manager 12 may conform to existing DRM standards, such as Windows Media Audio (WMA) PlaysForSure™ or Apple's FairPlay™, or employ “watermarking.” Alternatively, the depository/rights manager 12 may wish to provide proprietary DRM. Additionally, a depository/rights manager 12 may simply provide (or in addition to DRM) a proprietary user interface and control mechanism to restrict access, copying, and transfer to the underlying data.

Generally, the depository/rights manager 12, or another server or entity associated with it, will enable the end user to stream and/or download any of the media (or equivalents thereof) provided to the depository/rights manager 12. Prior to such playback, the depository/rights manager 12 may convert such data to different formats of players used by end-users to the extent consistent with legal restrictions, if any. Such transfer and conversion can be accomplished by any of the numerous methods well-known in the prior art or that are hereinafter introduced. In the event such change in media format is made, the depository/rights manager 12 may restrict simultaneous access by the end user to any prior formats downloaded in order to ensure compliance with copyright or other restrictions, if necessary.

The depository/rights manager 12 may restrict access to just streaming, just download, or neither, depending upon the rights of the end user. For instance, a user 14 that sells an audio CD to the depository/rights manager 12 would generally no longer have rights to stream or download any songs on the sold audio CD, unless provided by the copyright holder to the depository/rights manager 12 and/or user 14. In another example, the depository/rights manager 12 may wish to restrict streaming and download to one specific device of the end-user, by using, for example, the device's MAC address. Alternatively, the service may restrict download to one device but allow streaming to many devices. Of course, there are a number of permutations of access rights that should be clear from the disclosure herein to one of skill in the art.

If a user 14 desires to transfer data stored by the depository/rights manager 12 to a mobile device or media, such as an MP3 player or audio CD, the depository/rights manager 12 track any transfer by requiring the user to report a transfer, either by a real-time connection over the Internet, or another appropriate reporting mechanism, to the depository/rights manager 12.

For example, if a user desires to download a song to his MP3 player, the depository/rights manager 12 may use appropriate technological restrictions, like DRM or a proprietary user interface, to require the user to be online when transferring any songs to an MP3 player from another device, such as a desktop computer. In this manner, the depository/rights manager 12 may keep track of all instances of the song on any of the user's devices. This tracking may ensure that the user complies with applicable copyright and other restrictions on copying and transferring of the data.

In addition to storage, transmission, search, playback, and display features, users 14 may additionally designate certain data as available for sale, trade, or other exchange with other end users or other parties. For example, a user 14 may send to the depository/rights manager 12 fifty audio CDs plus ten video DVDs for conversion, storage, streaming, and download, designating twenty of the audio CDs and two of the video DVDs as available for sale, trade, or other exchange. The depository/rights manager 12 may allow the user to specify minimum dollar values for the sale of each item. Alternatively, the depository/rights manager 12 may simply provide “credits” for the exchange of a user's data, which can be used to purchase other data available from other users or the depository/rights manager 12.

If such data is exchanged, the seller/user 14 would typically then be precluded from downloading and/or streaming that data for playback or display, or from copying such data to mobile devices or media. Additionally, in order to ensure compliance with copyright and related restrictions, the depository/rights manager 12 may confirm prior to any such transfer that the user 14 has deleted or no longer has access to any copies the user 14 may have downloaded or made to mobile devices. Alternatively, media may be stored in a “contingent” state, whereby a user 14 may play that media, but it is “available for sale” with automatic deletion upon exchange with another user. In other situations, a user 14 may be notified by another user 14 (e.g., via an e-mail or instant message) with a request to exchange media. The first user 14 may then exchange the media with the second user 14 upon its deletion.

Furthermore, a user 14 may be “sponsored” by another entity owning copyright to certain data (such as a music publisher or movie studio) to provide the user 14 access to additional data that is owned by another user 14 or a copyright owner of such additional data. For instance, a copyright owner may wish to provide one user access to the first 10 minutes of a movie as a “teaser” to get the user to purchase or license rights to view the movie.

Once one user 14 has purchased or received via an exchange data from a second user 14, the second user has immediate access to the data, so as to be able to download, stream, copy to mobile devices or media, and/or exchange such data as the first user 14 was able to do.

The depository/rights manager 12, however, may wish to place restrictions on when the second user 14 is entitled to exchange such data in order to comply with copyright and related restrictions, if necessary. For example, the depository/rights manager 12 may wish to require the second user 14 to retain ownership, license rights, or other equivalent rights to an audio CD for at least 30 days before being able to exchange that album with another user 14.

Some media formats are subject to more restrictions under applicable copyright and other law, or under applicable licenses, than other formats. For example, in some contexts, video data is subject to greater restriction than audio data. In this instance, the depository/rights manager 12 may wish to curtail access to video data in a manner different from audio data submitted by the same user 14.

For the user 14, system 10 and depository/rights manager 12 may be accessed via traditional computer and communications network using a graphical user interface (GUI), for example, provided by a World Wide Web browser, or using a text-based interface. Alternatively, for users who do not have access to a computer or other device capable of accessing the Internet or another similar communications network, the system 10 may be accessed with an audio-only interface, e.g., over a telephone, using audio-output and input via touchtone (or other keypad entry) and/or speech recognition. Aspects of both visual-based and audio-based user interfaces may, of course, combined into one interface. These interfaces can be implemented on a telephone, computer, PDA, mobile phone, television, and other input/output devices. Methods of building suitable interfaces on a variety of devices are well-known in the art.

Of course, all of the features, operations, and types of transactions described above are only examples of the range of features, operations, and transactions that may take place in system 10. In the above description, it was assumed that the depository/rights manager 12 itself provided a service directly to users 14, which is why some users 14 are shown interacting directly with the depository/rights manager 12 in FIG. 1. However, in addition to providing its own interface and allowing users 14 to access the media management database and the stored media directly, in some embodiments, the depository/rights manager 12 may also provide an API to third parties, who would then implement their own interfaces and their own feature sets, using the media management database of the depository/rights manager 12 to handle back-end copyright compliance and transaction tracking. As shown in FIG. 1, some users 14 communicate, for example, over communication networks, with third parties 22, 24, 26 which use an API to communicate with and use data from the depository/rights manager 12. Although the third parties 22, 24, 26 that communicate with the depository/rights manager 12 in FIG. 1 are shown as interacting directly with users 14, in some embodiments, third parties 22, 24, 26 that use APIs to communicate with the depository/rights manager 12 may instead act as middlemen themselves, providing services to other third-party entities. In some embodiments, the depository/rights manager 12 may not communicate directly with users 14 at all; instead, acceptance of media 16, 18 could be through service partners 20 and access to the media management database generated by the depository/rights manager 12 could be through third parties 22, 24, 26 using APIs.

With or without APIs, system 10 may also be used as a part of other systems, so as to augment the capabilities of those systems. Use with other systems may allow users 14 to partake in additional features, such as access to various online radio or television stations, artist-“specific” radio stations, unlimited music subscription services, at-home digital video recording products and services, music trading services, and music download services.

The method 50 and system 10 described herein may be integrated with these existing services in a variety of manners. For example, with online radio and television stations, when a song, television show, or movie is played on the station and that data is also owned or licensed by the user 14, the user 14 may see a button that allows the user to automatically download the song, TV show, or movie, or exchange that song, television show, or movie with another user, or with the depository/rights manager 12. Additionally, the user 14 may hit a button to purchase the song, television show, or movie using a store of credits or dollars generated from the exchange of other data, or simply provided by the depository/rights manager 12 as credit against the user's data stored by the depository/rights manager 12.

For artist-specific radio stations, typically the chosen artist plus other similar artists are played to a listener. If a particular artist is played, the user 14 may wish to convert the station to a true artist-only station by purchasing some or all of those albums “on-the-fly” from other users 14, the depository/rights manager 12, or a third party. Alternatively, a user 14 could choose to listen to an artist-only station through such a purchase.

For unlimited subscription services, the system 10 and method 50 described herein may supplement the existing subscription service by providing users 14 the ability to exchange data not available on the subscription service, or by offering users credits or stored dollar value for exchanging data, which then may be used to purchase time on the subscription service or other data, such as songs, albums, movies, books, or the like. Similar complementary aspects would apply to a music download service. Moreover, to the extent a given user 14 had sufficient credit or other value to purchase or exchange sufficient data, a user 14 could create a real-time radio, television, or similar “station” with significantly more selection than currently available on unlimited subscription services or Internet-based radio stations.

Furthermore, social networking applications that link users to one another could be used enhance the ability for users to exchange data with one another and for users to learn what data other users are actively listening to, viewing, reading, etc. For example, if a first user has listened to a song repetitively over the course of a week, a message may be sent to other users in the first user's social network indicating that the song is “hot” for the first user. The other users might then be offered to listen to a clip of the song, then an option to purchase, license, or make an exchange for the song.

Finally, system 10 and method 50 expand exchange capabilities from pure hard format, e.g., one person exchanges an audio CD with another person, to virtual exchanges enabling two users to instantaneously have electronic access to soft media format files based on underlying exchanges of hard media format data. For example, two users may exchange two hard format audio CDs stored centrally by the depository/rights manager 12 via an online interface, with immediate access to the files on the newly acquired CD (and typically with concomitant immediate disabling of access for a user to the CD exchanged by that user). Alternatively, only one of the users may exchange the hard format CD, while the other user simply purchases the underlying data in soft format.

At any point, any user 14 may decide to withdraw media 16, 18 that he or she owns from the depository/rights manager 12. In that case, hard media 16 would be shipped back to the user 14 and the user's association with that media 16 would be removed, and soft media 18 would either be removed from the depository/rights manager 12 (e.g., if the withdrawing user 14 owned the only copy, or if the depository/rights manager 12 has stored a copy of the media specifically for the user 14) and/or the association of the user 14 with that media 18 would be removed (e.g., if the depository/rights manager 12 keeps one or more master copies to which many users 14 have rights). In some embodiments, users 14 may have unrestricted ability to withdraw any media 16, 18 to which they have rights; in other embodiments, and in particular situations, the rights of users 14 to withdraw media 16, 18 may be limited. For example, a user 14 may be able to withdraw media 16, 18 that he or she provided to the depository/rights manager 12 and currently owns without restriction, but may be restricted in his or her ability to withdraw media 16, 18 to which he or she acquired the rights through the depository/rights manager 12.

In some embodiments, the depository/rights manager 12 may charge a fee or take a commission for each transaction that transfers rights to a medium 16, 18, or may charge a fee each time content is listened to, viewed, or used through any other sensory modality. The depository/rights manager 12 may also charge a fee or take a commission when media 16, 18 is withdrawn by a user 14. The commissions and/or fees charged to the users 14 need not be the same for all users 14, and in many instances, different fee or commission schedules may be used for different users 14 and different circumstances. For example, a user 14 who is the original and current owner of a medium 16, 18 that he or she is seeking to use or to withdraw from the depository/rights manager 12 may be charged a lesser fee than a user 14 seeking to use or to withdraw media 16, 18 to which he or she has acquired the rights through the depository/rights manager 12. The depository/rights manager 12 may also charge a general or subscription fee for use. In some embodiments, the depository/rights manager 12 may cover some costs for the users 14, such as the cost of mailing hard media 16.

As those of skill in the art will realize, not all of the tasks of method 50 need be implemented in all embodiments. For example, at the user's request, hard format data provided by an end user may not be converted to soft format. Rather, the end user may simply request that the service provider store the hard format data for exchange. Alternatively, in some instances, it may not be financially worthwhile at a given time for the service provider to convert such media, in which event it simply stores the hard format data for later conversion or for exchange.

Additionally, the end user may desire not to send the service provider the hard media for conversion. In this scenario, the end user would perform any conversion at his or her location, uploading any soft format data to the service provider. Of course, such an approach may require authorization from the applicable copyright holder.

Moreover, rather than a centralized service providing conversion and storage with a single depository/rights manager 12, any or all of the tasks and aspects of the above system 10 and method 50 may be performed in a peer-to-peer, decentralized service according to techniques well-known in the art. For instance, a user might mail twenty-five audio CDs to a service provider, which then converts the audio CDs to soft format, transmits the soft format information back to the end user's computer or other device for storage, but the service provider does not store the soft format data. That user may then act as a storage point for a second user wishing to stream or download a particular song on one of the audio CDs mailed by the second-user to the service provider. In this example, it is assumed that the service provider stores the hard format audio CDs, e.g., in its warehouse, though decentralized storage (as described above and below) may alternatively be used. Of course, any number of permutations of centralized and/or distributed architectures for the various aspects of the method and system would be feasible.

While the invention has been described with respect to certain embodiments, the description is intended to be exemplary, rather than limiting. Modifications and changes may be made within the scope of the invention, which is set forth in the following claims.

What is claimed is:

1. A method comprising:
accepting media from a plurality of entities;
associating rights to the content of the accepted media with the respective entities that provided the media using a media management database;
selectively allowing the plurality of entities to transfer the rights to the content of the media; and
tracking the transfer of rights using the media management database.

2. The method of claim 1, wherein selectively allowing the plurality of entities to transfer the rights to the content of the media comprises allowing the transfer of rights if the media management database indicates that rights to the content are associated with the entity seeking to transfer the rights.

3. The method of claim 2, wherein the rights to the content of the media allow the entities with which the rights are associated to perform one or more actions selected from the group consisting of listening to the content, viewing the content, using the content, and transferring the content to another entity.

4. The method of claim 1, wherein the media comprises hard media or soft media.

5. The method of claim 4, further comprising, prior to associating the rights to the content with the providing entity, confirming that the media is authentic.

6. The method of claim 5, wherein associating the rights to the content with the providing entity comprises associating the rights to the content with the providing entity if the media is authentic.

7. The method of claim 4, further comprising, prior to associating the rights to the content with the providing entity, confirming that the media is useable.

8. The method of claim 7, wherein associating the rights to the content with the providing entity comprises associating the rights to the content with the providing entity if the media is useable.

9. The method of claim 4, wherein the media is hard media and the method further comprises digitizing the contents of the media to create a digital media file.

10. The method of claim 9, further comprising causing or allowing the entities to transfer the digital media file with the rights to the content of the media.

11. A method of distributing media, comprising:
providing the rights to media to a depository, the depository being adapted to associate the rights to the media with the entity that provided it; and
transferring the rights to the media to another entity using a communications network to effect the transfer with the depository acting to validate and record the transfer of rights.

12. The method of claim 11, wherein the depository is further adapted to determine whether the rights of the entity that provided the media are valid.

13. The method of claim 11, wherein providing the rights comprises providing the depository with hard media.

14. The method of claim 13, wherein the depository is adapted to determine whether the content of the media is available in a digital form and, if not, to digitize the content of the media.

15. The method of claim 14, further comprising transferring the rights to the media to the other entity comprises transferring the rights to the media in exchange for consideration.

16. The method of claim 11, wherein providing the rights comprises providing the depository with soft media.

17. A system comprising a depository adapted to (1) accept media from a plurality of entities, thereby accepting rights to that media, (2) associate the rights to the content of the media with the respective entity of the plurality of entities that provided the media, (3) store the associations in a media management database, and (4) record transfers of the rights to the media among the plurality of entities in the media management database, the depository being connected to a communications network so as to provide selective access to the media management database.

18. The system of claim 17, wherein the depository is further adapted to determine whether the rights of the entities to the media are valid.

19. The system of claim 17, wherein the depository is further adapted to translate the content of the media from a first format to a second format.

20. The system of claim 19, wherein the first format comprises an analog format and the second format comprises a digital format.
